(19) United States
(12) Patent Application Publication
(10) Pub. No.: US 2010/0219371 A1
(43) Pub. Date: Sep. 2, 2010

(54) COMPOSITIONS BASED ON ALKYLIMIDAZOLIDONE (METH)ACRYLATES

(75) Inventor: Jean-Michel Paul, Metz (FR)

Correspondence Address: ARKEMA INC.;PATENT DEPARTMENT - 26TH FLOOR, 2000 MARKET STREET, PHILADELPHIA, PA, 19103-3222, US

(73) Assignee: ARKEMA FRANCE, Colombes (FR)

(21) Appl. No.: 12/160,935

(22) PCT Filed: Jan. 3, 2007
(86) PCT No.: PCT/FR2007/050603

§ 371 Date: Jul. 15, 2008

(30) Foreign Application Priority Data
Jan. 23, 2006 (FR) 0600570

(51) Int. Cl. C09K 3/00

(52) U.S. Cl. 252/182.29

(57) ABSTRACT

The invention relates to special (meth)acrylic monomers, more particularly to solutions of alkylimidazolidone (meth)acrylates in heavy (meth)acrylic esters, and also to preparation thereof from solutions of alkylimidazolidone (meth)acrylates in water or in light (meth)acrylic esters. The solutions of the invention are particularly advantageous in UV-radiation-polymerizing or electron-beam-polymerizing paint or varnish applications

### FIELD OF THE INVENTION

The invention relates to special (meth)acrylic monomers and relates more particularly to solutions of alkylimidazolidone (meth)acrylates in (meth)acrylic esters and to their preparation and to their applications.

### PRIOR ART AND TECHNICAL PROBLEM

It is known, for example from the documents EP 1 293 502, EP 433 135, EP 712 846, EP 650 962 or EP 619 309, to prepare alkylimidazolidone acrylates or methacrylates (denoted by (meth)acrylates) of formula (I):

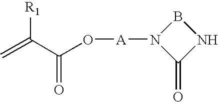

in which R₁ is a hydrogen atom or a methyl group and A and B represent, independently of one another, a straight- or branched-chain alkylene group having from 2 to 5 carbon atoms,

according to a transesterification process by reaction of at least one alkyl (meth)acrylate of formula (II):

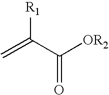

in which R₁ has the abovementioned meaning and R₂ is a straight- or branched-chain alkyl group having from 1 to 4 carbon atoms,

with a heterocyclic alcohol of formula (III):

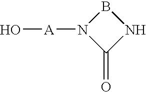

in which A and B have the abovementioned meanings,

in the presence of a catalyst.

When the (meth)acrylate (II) is in large excess with respect to the heterocyclic alcohol (III), a composition is obtained at the end of the reaction which comprises a solution of alkylimidazolidone (meth)acrylates of formula (I) in the (meth)acrylate (II).

Thus, alkylimidazolidone (meth)acrylates are generally sold in a light (meth)acrylate (II). More particularly, imidazolyl-2-one-1-ethyl (IOEM), prepared from methyl methacrylate (MMA), is sold in solution in methyl methacrylate (MMA).

It is known to replace methyl methacrylate by water in compositions comprising an alkylimidazolidone (meth)acrylate and methyl methacrylate obtained according to a transesterification process.

According to the document EP 1 241 163, the method consists in removing virtually all the methyl methacrylate by vacuum distillation under temperature/pressure conditions of 40° C. to 60° C./760 to 60 mmHG and in then adding the water. The final composition obtained comprises more than 50% of water.

According to the document EP 902 017, the method consists in introducing a small amount of water into the mixture comprising the alkylimidazolidone (meth)acrylate and the methyl methacrylate and in then removing the methyl methacrylate by distillation in the form of an azeotrope with water while continuously introducing water. The final composition obtained comprises approximately 48% of water.

Alkylimidazolidone (meth)acrylates are known for their role in the composition of polymers which can be used as coatings and adhesives, in the field of paper and textiles, for their use as leather treatment agents and in the production of emulsion paints.

However, alkylimidazolidone (meth)acrylates in solution in water or in a light (meth)acrylate, such as methyl methacrylate, exhibit drawbacks when they are employed. In particular, depending on the final use, the water exhibits the disadvantage of slow evaporation and the methyl methacrylate has a low vapor pressure and results in the emission of volatile organic compounds (VOCs).

Many advantages have now been found in replacing the water or the light (meth)acrylate by a heavier (meth)acrylic monomer which readily polymerizes under radiation in formulations of alkylimidazolidone (meth)acrylates in water or in a light (meth)acrylate. The heavier (meth)acrylic monomer, which acts as reactive solvent and which can be polymerized under radiation or under a beam of electrons, makes it possible to confer specific characteristics on the composition thus obtained, in particular to extend the field of use of alkylimidazolidone (meth)acrylates to that of the formulations which can be polymerized under UV radiation or under a beam of electrons, more particularly in the field of paints. The resulting problems of the emission of VOCs are thus avoided.

### SUMMARY OF THE INVENTION

A subject matter of the present invention is thus a composition comprising an alkylimidazolidone (meth)acrylate of formula (I):

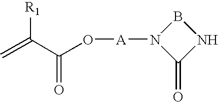

in which R₁ is a hydrogen atom or a methyl group and A and B represent, independently of one another, a straight- or branched-chain alkylene group having from 2 to 5 carbon atoms,

in solution in a (meth)acrylate of formula (IV):

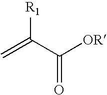

in which R₁ is a hydrogen atom or a methyl group and R′ is a straight- or branched-chain alkyl radical having from 9 to 40 carbon atoms or a cyclic aliphatic, alkenyl, aryl, alkylaryl or arylalkyl radical having from 2 to 40 carbon atoms, it being possible for these radicals to be substituted and to comprise heteroatoms, the composition additionally comprising a polymerization inhibitor.

Advantageously, the composition comprises from 20 to 80% by weight of alkylimidazolidone (meth)acrylate of formula (I) and of monomeric byproducts carrying a ureido functional group, preferably from 30 to 60% by weight and more particularly from 45 to 55% by weight. The monomeric byproducts carrying a ureido functional group are the byproducts inherent in the manufacture of the alkylimidazolidone (meth)acrylate of formula (I) by transesterification. They result from the addition of Michael type of the secondary amine functional group of the imidazolidone ring to another molecule of alkylimidazolidone (meth)acrylate (I) or to a molecule of alkyl (meth)acrylate (II). Generally, these byproducts are present at a content ranging from 5 to 25%, with respect to the alkylimidazolidone (meth)acrylate, in particular from 10 to 20%.

The invention also relates to a process for the preparation of solutions of alkylimidazolidone (meth)acrylate of formula (I):

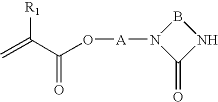

in which R₁ is a hydrogen atom or a methyl group and A and B represent, independently of one another, a straight- or branched-chain alkylene group having from 2 to 5 carbon atoms,

in a (meth)acrylate of formula (IV):

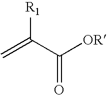

in which R₁ is a hydrogen atom or a methyl group and R′ is a straight- or branched-chain alkyl radical having from 9 to 40 carbon atoms or a cyclic aliphatic, alkenyl, aryl, alkylaryl or arylalkyl radical having from 2 to 40 carbon atoms, it being possible for these radicals to be substituted and to comprise heteroatoms,

starting from solutions of alkylimidazolidone (meth)acrylate of formula (I) in water or in a (meth)acrylate of formula (II):

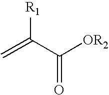

in which R₁ is a hydrogen atom or a methyl group and R₂ is a straight- or branched-chain alkyl group having from 1 to 4 carbon atoms.

Another subject matter of the invention is the use of the abovementioned compositions in the preparation of polymers which can be used as coatings and adhesives, in the treatment of paper and textiles, as leather treatment agents and in the production of paints or varnishes which can be polymerized by heating or under UV or visible radiation or under a beam of electrons.

Other characteristics and advantages of the invention will more clearly emerge on reading the description which follows.

### DETAILED ACCOUNT OF THE INVENTION

Mention may be made, as examples of compound (I), of those for which the group A is an alkylene group having 2 carbon atoms and more particularly imidazolidyl-2-one-1-ethyl methacrylate (IOEM).

Mention may be made, as examples of radicals R′ in the formula (IV), of the lauryl radical, stearyl radical, dodecyl radical, behenyl radical, isobornyl radical, phenyl radical, naphthyl radical or naphthyloxyalkyl radical comprising a linear or branched alkyl group having from 1 to 10 carbon atoms.

The acrylates of formula (IV) are preferred and more particularly isobornyl acrylate.

A preferred composition comprises from 45 to 55% by weight of IOEM and of monomeric byproducts carrying a ureido functional group and from 55 to 45% of isobornyl (meth)acrylate; preferably, the IOEM content is greater than 35%.

The compositions according to the invention can comprise one or more polymerization inhibitors, such as phenothiazine, hydroquinone, hydroquinone monomethyl ether, di(tert-butyl)-para-cresol, para-phenylenediamine, TEMPO (2,2,6,6-tetramethyl-1-piperidinyloxy) and di(tert-butyl)catechol, or TEMPO derivatives. The content of polymerization inhibitors is between 100 and 2000 ppm, with respect to the final mixture, preferably from 200 to 600 ppm.

The solutions of alkylimidazolidone (meth)acrylate of formula (I) in a (meth)acrylate (IV) are prepared from starting solutions of alkylimidazolidone (meth)acrylate of formula (I) in water or in a (meth)acrylate of formula (II):

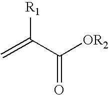

in which R₁ is a hydrogen atom or a methyl group and R₂ is a straight- or branched-chain alkyl group having from 1 to 4 carbon atoms.

The process consists in replacing the water or the (meth)acrylate of formula (II) with a (meth)acrylate of formula (IV).

Preferably, the (meth)acrylate (II) is a light (meth)acrylate, such as methyl (meth)acrylate or ethyl (meth)acrylate.

The content of alkylimidazolidone (meth)acrylate and monomeric byproducts carrying a ureido functional group in the starting solution is not critical; it is generally from 20 to 80%, preferably from 40 to 60% and more particularly from 45 to 55%. The starting solution can be stabilized with one or more polymerization inhibitors, among which may be mentioned phenothiazine, hydroquinone, hydroquinone monomethyl ether, di(tert-butyl)-para-cresol, para-phenylenediamine, TEMPO (2,2,6,6-tetramethyl-1-piperidinyloxy) and di(tert-butyl)catechol, or TEMPO derivatives.

The starting solutions of alkylimidazolidone (meth)acrylate of formula (I) in water or in a light (meth)acrylate of formula (II) can be obtained according to one of the processes known to a person skilled in the art, such as mentioned above, or are available commercially.

The process according to the invention can be carried out according to various embodiments.

According to a first embodiment, the solution of alkylimidazolidone (meth)acrylate in a (meth)acrylate (II), and the replacement (meth)acrylate (IV), are initially charged to a reactor and the light (meth)acrylate is removed by vacuum distillation. The pressure is adjusted so as not to exceed a temperature of between 50° C. and 80° C. in the mixture during the distillation. It is possible to operate in a stirred reactor or using a rotary or thin film evaporator.

According to a second embodiment, the solution of alkylimidazolidone (meth)acrylate in a (meth)acrylate (II) is introduced into a reactor and a portion of the (meth)acrylate (II) is distilled off; advantageously, 20 to 70% of the (meth)acrylate (II) present in the alkylimidazolidone (meth)acrylate solution and preferably 40 to 60% are distilled off during this stage. The replacement (meth)acrylate (IV) is then added continuously while continuing to distil off the (meth)acrylate (II).

It is possible to proceed in the same way with solutions of alkylimidazolidone (meth)acrylate in water.

In both embodiments, bubbling with air, optionally depleted (8 to 9% O₂), is carried out.

A final stripping, consisting in exhausting the light compounds with depleted air comprising 8 to 9% of O₂, can be carried out, making it possible to complete the removal of the (meth)acrylate (II) in the mixture.

The residual content of (meth)acrylate (II) in the solution obtained is generally less than 5%, preferably less than 1%.

The compositions according to the invention and the solutions obtained according to the process of the invention exhibit numerous advantages from the viewpoint of their applicative properties, more particularly in the field of paints, due to the presence of the (meth)acrylate (IV), which acts as reactive solvent which can be polymerized by heating in the presence of a radical initiator, or under UV or visible radiation in the presence of photoinitiators, or under a beam of electrons.

The following examples illustrate the present invention without, however, limiting the scope thereof.

### Exemplary Embodiments

The following abbreviations are used therein:
HEIO: 1-(2-hydroxyethyl)imidazolidin-2-one
IOEM: imidazolidyl-2-one-1-ethyl methacrylate
Norsocryl©104: 50% by weight solution of imidazolidyl-2-one-1-ethyl methacrylate and monomeric impurities of ureido type in methyl methacrylate
MMA: methyl methacrylate
HQME: hydroquinone methyl ether
PTZ: phenothiazine
ISOBORA: isobornyl acrylate
ISOBORMA: isobornyl methacrylate

The percentages are expressed as percentages by weight.

### Example 1

1000 g of Norsocryl©104 and 480 g of ISOBORA are charged to a device composed of a rotary evaporator.

The MMA is distilled off at a temperature of the bottom mixture of 50° C. while adjusting the working pressure (from 60 mmHg to 15 mmHg at the end).

After the MMA has been distilled off, and after cooling, a clear homogeneous solution is recovered which comprises 42% of IOEM, 3% of MMA, 49% of ISOBORA, 2% of HEIO and 4% of impurities.

### Example 2

Use is made of a rotary evaporator with a greater capacity of Quickfit M200 type with a capacity of 20 liters and with a rotational speed of 12-95 revolutions per minute.

8.0 kg of Norsocryl© 104, which comprises 39.6% of IOEM, 1.0% of HEIO, 52.3% of MMA, 0.017% of HQME and 0.046% of PTZ, are charged.

The temperature in the evaporator is maintained between 40 and 56° C. by adjusting the working pressure between 23 and 34 mbar (P absolute). 4.02 kg of MMA are distilled off in 3 h 45 min.

4.0 kg of ISOBORA are then charged in 15 min. After stirring for 20 min, the mixture is cooled to 30° C. and is emptied, after having brought the pressure back to atmospheric pressure. Throughout the test, bubbling of air into the mixture is maintained.

At the end, 7.83 kg of mixture are obtained, which mixture has the following composition by weight:
IOEM: 37.5%
ISOBORA: 54.1%
MMA: 1.0%
Others: 7.2%
HQME: 0.023%
PTZ: 0.043%

### Example 3

Example 1 is repeated while replacing ISOBORA with ISOBORMA.

A mixture is obtained which comprises:
IOEM: 38.0%
ISOBORMA: 54.0%
MMA: 0.5%
Others: 7.5%
HQME: 0.022%
PTZ: 0.044%

### Example 4

The mixture is in this instance prepared in a stirred reactor heated by circulation of oil in a jacket and surmounted by a distillation column.

387 g of Norsocryl©104, which comprises 39.6% of IOEM, 1.0% of HEIO, 52.3% of MMA, 0.017% of HQME and 0.046% of PTZ, are charged. Bubbling of air into the reactor is maintained throughout the operation and the medium is heated to a temperature which must remain between 70 and 75° C. To do this, the working pressure is gradually lowered from 300 mmHg to 50 mmHg.

The MMA is removed by distillation. When 184 ml of MMA have been distilled off, the continuous introduction of 186 g of ISOBORA over one hour is begun. When all the ISOBORA has been introduced, bubbling of air is increased in order to remove the traces of residual MMA. Stripping is carried out under 15 mmHg of pressure. The final product exists in the form of a clear yellow homogeneous liquid comprising 0.5% of residual MMA.

### Example 5

600 kg of Norsocryl©104 are charged to a stirred reactor heated via a jacket and the temperature in the reactor is brought to approximately 38° C. (column top pressure 50 mmHg) while distilling off a portion of the MMA present in the Norsocryl©104. When the amount of MMA distilled off reaches 150 kg, 150 kg of ISOBORA are charged to the reactor. Distillation of the MMA is continued while gradually lowering the working pressure down to 30 mmHg at the column top in order not to exceed 50° C. in the reactor. When the temperature of the reactor reaches 50° C., 100 kg of ISOBORA are introduced all at once. The amount of MMA which was distilled off during this stage is 103 kg. The distillation of the MMA is again continued while gradually lowering the pressure down to 20 mmHg at the column top. When the temperature of the reactor reaches 70° C., the additional MMA distilled off represents 38.5 kg. 41.9 kg of ISOBORA are then introduced into the reactor. Stripping is subsequently carried out in order to remove the residual MMA. Throughout the duration of the operation, the column is stabilized with a solution of HQME in ISOBORA and bubbling of depleted air, comprising 7% of oxygen by volume, into the reactor is carried out.

The final mixture comprises:
IOEM: 40%
ISOBORA: 50.0%
MMA: 0.7%
Others: 9.3%
HQME: 0.015%
PTZ: 0.035%

1. A composition comprising an alkylimidazolidone (meth)acrylate of formula (I): 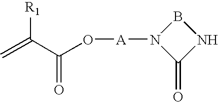
in which R₁ is a hydrogen atom or a methyl group and A and B represent, independently of one another, a straight- or branched-chain alkylene group having from 2 to 5 carbon atoms,
in solution in a (meth)acrylate of formula (IV): 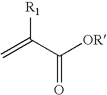
in which R₁ is a hydrogen atom or a methyl group and R′ is a straight- or branched-chain alkyl radical having from 9 to 40 carbon atoms or a cyclic aliphatic, alkenyl, aryl, alkylaryl or arylalkyl radical having from 2 to 40 carbon atoms, said radicals being substituted or unsubstituted or heteroatoms,
and additionally comprising a polymerization inhibitor.

2. The composition as claimed in claim 1, comprising from 20 to 80% by weight of alkylimidazolidone (meth)acrylate of formula (I) and monomeric byproducts carrying a ureido functional group.

3. The composition as claimed in claim 1, characterized in that the compound of formula (I) is imidazolidyl-2-one-1-ethyl methacrylate.

4. The composition as claimed in claim 1, characterized in that, in the formula (IV), the radical R′ is selected from lauryl, stearyl, dodecyl, behenyl, isobornyl, phenyl, naphthyl or naphthyl oxyalkyl comprising a linear or branched alkyl group having from 1 to 10 carbon atoms.

5. The composition as claimed in claim 1, characterized in that the (meth)acrylate (IV) is isobornyl acrylate.

6. The composition as claimed in claim 1, characterized in that the polymerization inhibitor is selected from phenothiazine, hydroquinone, hydroquinone monomethyl ether, di(tert-butyl)-para-cresol, para-phenylenediamine, TEMPO (2,2,6,6-tetramethyl-1-piperidinyloxy), di(tert-butyl)catechol, or TEMPO derivatives.

7. The composition as claimed in claim 1, characterized in that the content of said polymerization inhibitor comprises between 100 and 2000 ppm, with respect to the final mixture.

8. A process for the preparation of solutions of alkylimidazolidone (meth)acrylate of formula (I): 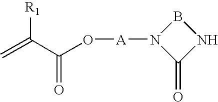
in which R₁ is a hydrogen atom or a methyl group and A and B represent, independently of one another, a straight- or branched-chain alkylene group having from 2 to 5 carbon atoms,
in a (meth)acrylate of formula (IV): 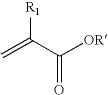
in which R₁ is a hydrogen atom or a methyl group and R′ is a straight- or branched-chain alkyl radical having from 9 to 40 carbon atoms or a cyclic aliphatic, alkenyl, aryl, alkylaryl or arylalkyl radical having from 2 to 40 carbon atoms, said radicals being substituted or unsubstituted or heteroatoms, comprising
reacting solutions of alkylimidazolidone (meth)acrylate of formula (I) in water or in a (meth)acrylate of formula (II): 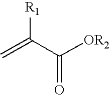
in which R₁ is a hydrogen atom or a methyl group and R₂ is a straight- or branched-chain alkyl group having from 1 to 4 carbon atoms.

9. The process as claimed in claim 8, characterized in that the alkylimidazolidone (meth)acrylate is imidazolidyl-2-one-1-ethyl methacrylate.

10. The process as claimed in claim 8, characterized in that the (meth)acrylate (IV) is isobornyl acrylate.

11. (canceled)

12. A composition comprising from 45 to 55% by weight of imidazolidyl-2-one-1-ethyl methacrylate and of monomeric byproducts carrying a ureido functional group and from 55 to 45% by weight of isobornyl (meth)acrylate.

13. The composition as claimed in claim 1, comprising from 30 to 60% by weight of alkylimidazolidone (meth)acrylate of formula (I) and monomeric byproducts carrying a ureido functional group.

14. The composition as claimed in claim 1, characterized in that the content of said polymerization inhibitor comprises between 200 and 600 ppm, with respect to the final mixture.
